(19) United States
(12) Patent Application Publication
(10) Pub. No.: US 2003/0065927 A1
(43) Pub. Date: Apr. 3, 2003

(54) Method and apparatus for copy protecting hardware devices

(76) Inventor: Miles J. Penner, Portland, OR (US)

Correspondence Address: Todd M. Becker, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/966,848

(22) Filed: Sep. 28, 2001

(51) Int. Cl. H04L 9/00

(52) U.S. Cl. 713/189

(57) ABSTRACT

A process is disclosed comprising storing a first code in a memory of a device, wherein the first code uniquely identifies the device, and storing encrypted data in the memory, wherein the encrypted data comprises a second code that identifies the device. Also disclosed is an apparatus comprising a device comprising a memory, a first code stored in the memory, wherein the code uniquely identifies the device, and an encrypted data set stored in the memory, wherein the data set comprises a second code which identifies the device.

### TECHNICAL FIELD

This disclosure relates generally to copy protection of hardware, and in particular, but not exclusively, relates to computer hardware including measures to prevent copying.

### BACKGROUND

Software piracy is a common and well-known problem that plagues the computer industry. Less well known and less common, but equally damaging, is the problem of hardware piracy. Hardware piracy does not refer to stealing actual hardware from a manufacturer (that would described simply as “theft”), but rather to unauthorized copying of a hardware designed by a manufacturer. Hardware manufacturers spend substantial amounts of money designing computers and sub-components of computers, such as modems and other network communication devices, video cards, hard-drive controllers, and so on. Hardware piracy costs manufacturers plenty, because unauthorized manufacturers obtain the benefits of the manufacturers investment without any investment of their own. Manufacturers who set the standards for certain components, or whose products are in high demand, are particularly vulnerable to hardware piracy.

Hardware piracy has detrimental effects to both the manufacturer and to the ultimate end-user. For the manufacturer, hardware piracy reduces their profits, deprives them of the benefit of their investment in the development of the particular hardware, and may seriously affect the company's reputation and image if the copied hardware is passed off as having come from the original manufacturer. The consumer suffers because they end up with a product that may or may not perform as well as the original, may adversely affect the performance of their computer or damage their computer. Additionally, if the copied hardware is passed off as that of a premium manufacturer, the consumer may end up paying an unjustified premium for it.

There are legal remedies for hardware piracy that a manufacturer can pursue in some situations. For example, where a hardware design is obtained as a result of industrial espionage or other theft of a trade secret, the manufacturer can take legal measures to pursue the copier. Unfortunately, however, legal process is slow and remedies are retrospective, so by the time any legal remedy can be had the damage is done and the manufacturer cannot fully recover its loss.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a drawing of an embodiment of a device of the present invention.

FIG. 2 is an embodiment of a data set to be encrypted according to an embodiment of the invention.

FIG. 3 is a flowchart illustrating a part of an embodiment of the present invention.

FIG. 4 is a flowchart illustrating a second part of the embodiment of the present invention whose first part is shown in FIG. 3.

### DETAILED DESCRIPTION OF THE ILLUSTRATED EMBODIMENTS

Embodiments of a system and method for hardware copy protection are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

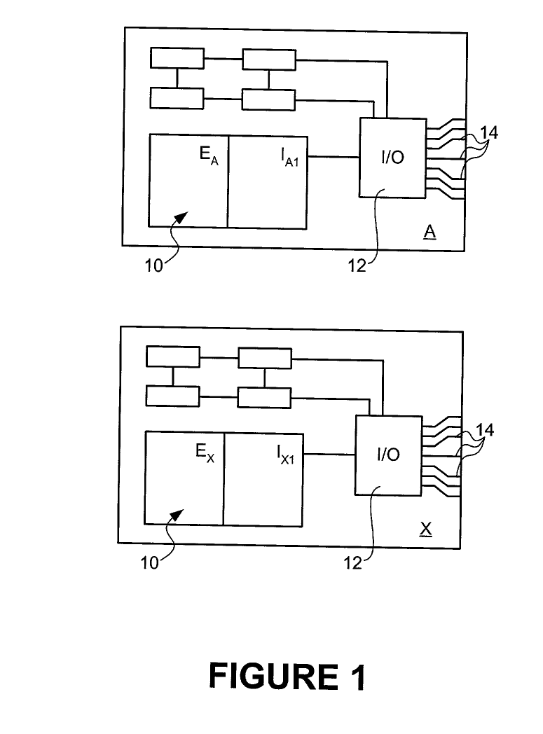

FIG. 1 illustrates one embodiment of the present invention using an authorized network adapter A and an unauthorized network adapter X. The unauthorized adapter X is so called because it is copy of the network adapter A made by an unauthorized manufacturer. The authorized adapter A includes, among other things, a memory 10, and an input-output (I/O) chip 12. The memory 10 can be any type of non-volatile memory, such as an Electronic Erasable Programmable Read Only Memory (EEPROM), Erasable Programmable Read Only Memory (EPROM), flash memory, and the like. The I/O chip 12 allows communication via pins 14 between the network adapter A and other components in a system, for example a computer or server.

Stored in the memory 12 of the communication adapter A there is, among other things, an identification code I_{A1} that uniquely identifies the adapter. For a network adapter conforming to the IEEE 802 standard, the unique code I_{A1} is a Media Access Control (MAC) address, a hardware address that uniquely identifies each node in a network. In any network, each network adapter A must have a unique MAC address; otherwise, the network server will be unable to differentiate between the different computers connected to the network. Generally, an authorized manufacturer is allocated a block of MAC numbers for its network adapters. The manufacturer sells its adapters to an Original Equipment Manufacturer (OEM) without an assigned MAC number, and the manufacturer must authorize the OEM to use MAC addresses from the OEM's allocation of MAC addresses for specific models or groups of network adapters. When the manufacturer sells directly to end users, however, it assigns a MAC address to the card before delivery to the end users. Although described herein in the context of network adapters, the adapters A and X could equally well be any other kind of device that includes a memory and is identified by some unique identification number or code.

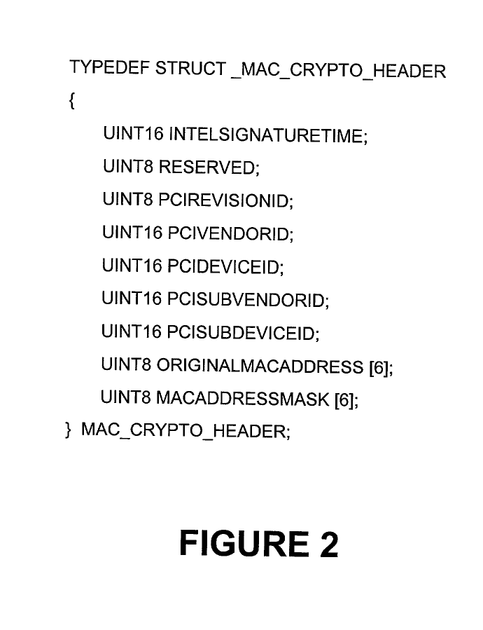

In addition to the unique identification code I_{A1}, the memory 12 has stored thereon an encrypted data set E_{A}. The encrypted data set E_{A} results from encrypting an unencrypted data set M which includes, among other things, a unique code I_{A2} identical to I_{A1}. FIG. 2 illustrates an embodiment of the data set or message M for use with a network adapter conforming to the IEEE 802 standard; in other embodiments, however, the message M may contain more, less, or different information than that shown. Among other things, the data set or message M contains the unique identifier I_{A2}, which will also be the MAC number assigned to the network adapter A onto which the encrypted message E_{A} will be written. Using the operational notation E(K,M) to denote the encryption of data set M using an encryption key K,

I_{A2}εM and

E_{A}=E(K,M)

In operation of the authorized network adapter A, a driver that runs the adapter A will first decrypt the encrypted data set E_{A}, thus returning it to its unencrypted form M. Thus, using D(K, M) to denote the decryption of data set E_{A} using encryption key K, the driver performs the operation

D(K,E_{A})=D(K,E(K,M))=M.

Having obtained the data set M, the driver then compares the code I_{A2} found within the data set M with the identification code I_{A1} found in the memory 12 or elsewhere on the adapter A. If the identification code I_{A2} from the data set M is identical to the code I_{A1} found elsewhere in the memory, then the adapter A is authorized, and the driver loads itself onto the network adapter A so that it can perform its job. If the above condition is not met and the identifier I_{A2} does not match the code I_{A1}, then the adapter is an unauthorized adapter X. Should the adapter turn out to be unauthorized, the driver can take various actions, such as notifying a user that they have an unauthorized adapter, or setting the driver so that it will not load itself onto an unauthorized adapter X.

The encryption scheme chosen to encrypt the data set M and decrypt the data set E_{A} is preferably a statistically strong one; in other words, it should be an encryption scheme that is difficult to break. In one embodiment, the encryption and decryption operations described above are carried out using a public/private encryption scheme. In a public/private encryption scheme, data is encrypted using a private encryption key and is decrypted using a public encryption key. The public key can only be used to decrypt data that was encrypted with the corresponding private key. Examples of public/private encryption schemes include Advanced Encryption Standard (AES), a symmetric, or public/private, algorithm supporting variable length blocks of data. Using a public/private key encryption scheme with a private key K and a public key Kₚ,

E_{A}=E(K,M) and

M=D(K_{P},E_{A}).

In one example using a public/private key encryption scheme the data set M could be encrypted using a manufacturer's private key and the encrypted data set E_{A} is stored in the memory of the network adapter. The driver that runs the adapter would then use the manufacturer's public key to decrypt the data set M, extract the code I_{A2} and compare it to the code I_{A1} stored on the adapter.

Alternatively, or in addition, multiple levels of encryption could be used to encrypt the data set M. For example, encrypting the data set M twice, once with a first private encryption key K₁ and once with a second private encryption key K₂, the following would be true of the encrypted data set E_{A}:

E_{A}=E(K₂,E(K₁,M)).

Of course, if multiple levels of encryption are used to encrypt the data set M, then multiple levels of decryption would be used to decrypt the data set E_{A}, and the number of levels of decryption would match the number of levels of encryption. Thus, if Kₚ₁ and K_{P2} are the public keys corresponding respectively to private keys K₁ and K₂, then

M=D(K_{P2},D(K_{P1}, E_{A})).

When the network adapter A arrives in the hands of an end user, it is usually as part of a system such as a server, desktop or laptop computer, and will have been handled by at least two parties: the authorized manufacturer of the adapter, and an Original Equipment Manufacturer (OEM) who installs the adapter A in the larger system, and then sells it to the end user. In one embodiment, the data set M is encrypted twice—once with a private key of the manufacturer, and once with a private key of the OEM. The driver that operates the adapter then decrypts the data set M using the public keys of both the OEM and the manufacturer. In this way, responsibility for preventing hardware copying is shared by both the manufacturer and the OEMs to which it sells its adapters. Other embodiments using different combinations of keys are also possible. For example, in a case where the manufacturer sells directly to end user (i.e., there is no OEM in the supply chain), then the manufacturer could encrypt the data set M twice using two different private keys of its own. Similarly, in a case where there are more than two parties in the supply chain, the data set could also be encrypted more than twice, using private keys of each party in the supply chain. Responsibility for preventing hardware theft would thus be shared by all parties in the supply chain.

Also shown in FIG. 1 is an unauthorized network adapter X. The adapter X will have been assigned an identification code I_{X1} by the unauthorized manufacturer, and the code I_{X1} will be stored in the memory. In the case of a network adapter conforming to the IEEE 802 standard, the code I_{X1} is the MAC numbers assigned to the adapter X by the unauthorized manufacturer. The unauthorized manufacturer can attempt to create a data set M including an identifier I_{X2}, encrypt it into an encrypted data set E_{X}, and store it on the memory. The unauthorized manufacturer, however, does not possess the proper encryption key necessary to encrypt the data M. Because the data set M will not have been encrypted with the proper encryption key, the driver will either be unable to decrypt the data set E_{X} or will decrypt it in such a way that the code I_{X2} contained in the encrypted data M will not match the code I_{X1} assigned to the adapter X by the unauthorized manufacturer. The driver with thus determine that the adapter is, in fact, an unauthorized adapter X. In such a case, the driver can take various actions, such as notifying a user that they have an unauthorized adapter, or setting the driver so that it will not load itself onto an unauthorized adapter X.

One way an unauthorized manufacturer could circumvent this embodiment is by making an exact copy of the entire memory of an adapter A, and then transferring that exact copy to the memory of adapter X; in such a case, both the unencrypted code I_{A1} and the encrypted data set E_{A} containing the code I_{A2} are copied onto the unauthorized adapter X, such that I_{X1}=I_{A1} and E_{X}=E_{A}, such that I_{X2}=I_{A2}. Upon performing the decryption described above, the driver would find that the identifier I_{X2} matches the code I_{X1}, and would conclude that the adapter is an authorized one. Such a scheme would not be practical for an unauthorized manufacturer, however, because it would either have to copy the memory from one adapter A to many adapters X, such that all adapters X would have the same identification code I_{X1}, or it would have to obtain one authorized adapter A for every adapter X it wished to produce, so that the adapters X would not have duplicate identification code. Fortunately, neither of these options is feasible for an unauthorized manufacturer: the first would certainly lead to customer complaints, particularly for large customers who network many computers, and the second would be too expensive.

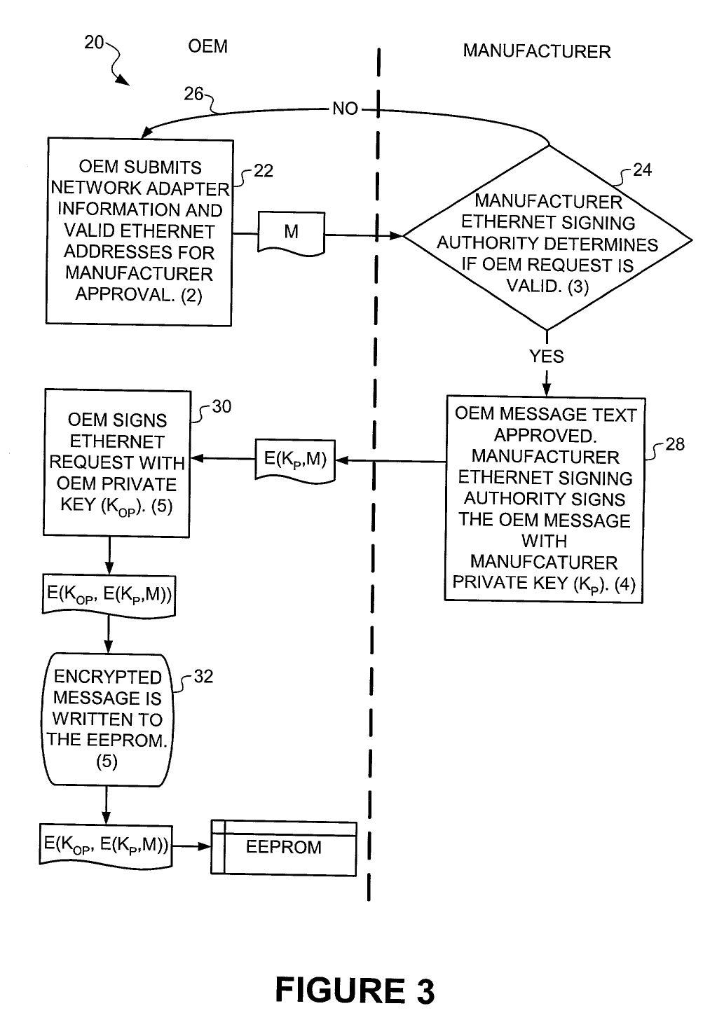

FIG. 3 illustrates an embodiment of a process 20 by which an authorized manufacturer and an OEM cooperate to prevent unauthorized copying of adapters. The dashed line in the figure indicates the delineation between tasks performed by the OEM and tasks performed by the authorized manufacturer. Although shown as a process including the participation of only two parties (OEM and manufacturer), the process could also take place with more or less parties involved.

Beginning at 22, the OEM submits for approval by the manufacturer network adapter information and Ethernet or MAC addresses which it proposes to use for its adapters. The information submitted by the OEM for each network adapter is contained in a data set or message M. At 24, the manufacturer receives the message M and determines whether the request from the OEM is valid—that is, whether the request comes from an OEM to whom legitimate sales have been made, and whether it requests valid MAC or Ethernet addresses. If the request is not valid, the manufacturer notifies the OEM at 26 and informs the OEM of the request's invalidity, and the OEM must then submit new information to the manufacturer for approval. If the request is valid, then at 28 the manufacturer approves the data set or message M submitted by the OEM. Once approved, the manufacturer “signs” the data set or message M by encrypting it with its own private key Kₚ, resulting in an encrypted data set or message E(Kₚ,M). At 30, the manufacturer sends the encrypted message M to the OEM, which encrypts the encrypted message E(Kₚ,M) with its own private key Kₒₚ, resulting in a twice-encrypted message E(Kₒₚ,E(Kₚ,M)). Finally, at 32, the twice-encrypted message E(Kₒₚ,E(Kₚ,M)) is written onto the memory 10 of the network adapter A, in this case to the EEPROM of the adapter A.

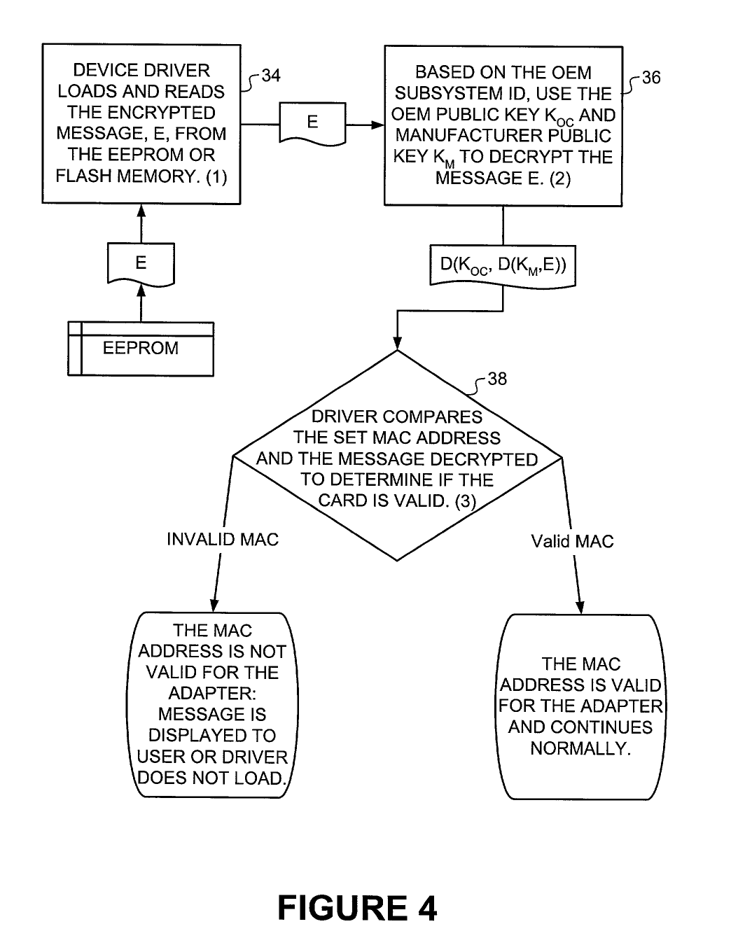

FIG. 4 illustrates an embodiment of a process by which a driver that operates the network adapter determines whether the adapter is an authorized adapter A or an unauthorized adapter X. At 34, the driver loads into the network adapter and reads the encrypted data set or message E from the memory 10, which can be any kind of non-volatile memory such as EEPROM. As described above, the encrypted message E results from two levels of encryption, such that E=E(Kₒₚ,E(Kₚ,M)).

Once the device driver loads the encrypted data set or message E from the EEPROM, at 36 it uses the public keys of the OEM the manufacturer to decrypt the message E, which was previously encrypted using the private keys of the manufacturer and the OEM. The decryption takes place in the reverse order of the encryption; that is, the message is first decrypted using the public key K_{oc} of the OEM, and then decrypted using the public key K_{M} of the manufacturer. The resulting decrypted message D(K_{oc},D(Kₘ,E)) is thus the result of the two levels of decryption. At 38, the driver compares the unencrypted MAC address stored in the memory with the MAC address found in the decrypted message to determine if the network adapter is authorized or unauthorized. If the decrypted MAC address does not match the unencrypted MAC address found in the memory, this means that the MAC address is not valid for the adapter. The driver can then take various actions, such as notifying a user that they have an unauthorized adapter, or refusing to load itself onto the unauthorized adapter X. If the MAC address from the decrypted message does match the unencrypted MAC address found on the memory, then the MAC address is valid for the adapter, the adapter is an authorized one, and the driver proceeds with normal loading an operation. Of course, different encryption schemes can be used in the present invention. For example, the original message M may be encrypted more or less then twice as shown, or may be encrypted using different varieties of keys, and using different encryption algorithms, such as AES or 3DES.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

[image]

[image]

1. A process comprising:
storing a first code in a memory of a device, wherein the first code uniquely identifies the device; and
storing encrypted data in the memory, wherein the encrypted data comprises a second code which identifies the device.

2. The process of claim 1 wherein storing the encrypted data on the device comprises:
creating once-encrypted data by encrypting the data using a first encryption key;
encrypting the once-encrypted data using a second encryption key to create the encrypted data; and
storing the encrypted data on the device.

3. The process of claim 2 wherein the first encryption key is a private key and the second encryption key is a private key.

4. The process of claim 1, further comprising:
decrypting the encrypted data using software adapted to operate the device;
comparing the first code to the second code; and
loading the software onto the device if the first code is identical to the second code.

5. The process of claim 4 wherein decrypting the data using the software comprises:
reading the encrypted data from the device;
decrypting the encrypted data using a first decryption key, wherein the result comprises once-decrypted data; and
decrypting the once-decrypted data using a second decryption key.

6. The process of claim 5 wherein the first decryption key is a public key and the second decryption key is a public key.

7. The process of claim 1 wherein the device is a network adapter and the software is a driver adapted to run on the device.

8. An article of manufacture, comprising:
a machine-readable medium having instructions stored thereon to:
store a first code in a memory of a device, wherein the first code uniquely identifies the device; and
store encrypted data in the memory, wherein the encrypted data comprises a second code which identifies the device.

9. The article of manufacture of claim 8 wherein the instructions to store encrypted data in the memory comprise instructions to:
create once-encrypted data by encrypting the data using a first encryption key;
encrypt the once-encrypted data using a second encryption key to create the encrypted data; and
store the encrypted data on the device.

10. The article of manufacture of claim 9 wherein the first encryption key is a private key and the second encryption key is a private key.

11. The article of manufacture of claim 8, wherein the instructions further comprise instructions to:
decrypt the encrypted data using software adapted to run on the device;
compare the first code to the second code; and
load the software onto the device if the first code is identical to the second code.

12. The article of manufacture of claim 11 wherein the instructions to decrypt the encrypted data comprise instructions to:
read the encrypted data from the device;
decrypt the encrypted data using a first decryption key wherein the result comprises once-encrypted data; and
decrypt the once-decrypted data using a second decryption key.

13. The article of manufacture of claim 12 wherein the first decryption key is a public key and the second decryption key is a public key.

14. An apparatus comprising:
a device comprising a memory;
a first code stored in the memory, wherein the code uniquely identifies the device; and
an encrypted data set stored in the memory, wherein the data set comprises a second code which identifies the device.

15. The apparatus of claim 14 wherein the encrypted data set is encrypted a first time with a first encryption key, and the result of the first encryption is encrypted using a second encryption key.

16. The apparatus of claim 15 wherein the first encryption key is a private key and the second encryption key is a private key.

17. The apparatus of claim 14 further comprising software operative with the device to:
decrypt the encrypted data set;
compare the first code to the second code; and
load the software onto the device if the first code and second codes are identical.

18. The apparatus of claim 17 wherein the software being operative with the hardware to decrypt the encrypted data set comprises the software being operative with the device to:
read the encrypted data from the device;
decrypt the encrypted data using a first decryption key, the result being once-decrypted data; and
decrypt the once-decrypted data using a second decryption key.

19. The apparatus of claim 18 wherein the first decryption key is a public key and the second decryption key is a public key.

20. The apparatus of claim 14 wherein the device is a network adapter.

21. The apparatus of claim 14 wherein the memory comprises a non-volatile memory.

22. The apparatus of claim 21 wherein the non-volatile memory is selected from among a group consisting of Electronic Erasable Programmable Read Only Memory (EEPROM), Erasable Programmable Read Only Memory (EPROM), and flash memory.

23. A system comprising:
a computer;
a device comprising a memory, wherein the device is installed in the computer;
a first code stored in the memory, wherein the code uniquely identifies the device; and
an encrypted data set stored in the memory, wherein the data set comprises a second code which identifies the device.

24. The system of claim 23 wherein the encrypted data set is encrypted a first time with a first encryption key, and the result of the first encryption is encrypted using a second encryption key.

25. The system of claim 22 wherein the first encryption key is a private key and the second encryption key is a private key.

26. The system of claim 23 further comprising software operative with the device to:
decrypt the encrypted data set;
compare the first code to the second code; and
load the software into the device if the first code and second codes are identical.

27. The system of claim 26 wherein the software being operative with the hardware to decrypt the encrypted data set comprises the software being operative with the device to:
read the encrypted data from the device;
decrypt the encrypted data using a first decryption key, the result being once-decrypted data; and
decrypt the once-decrypted data using a second decryption key.

28. The system of claim 27 wherein the first decryption key is a public key and the second decryption key is a public key.
